(19) United States
(12) Patent Application Publication
(10) Pub. No.: US 2023/0351381 A1
(43) Pub. Date: Nov. 2, 2023

(54) SYSTEMS AND METHODS FOR A MULTI-LAYER, MULTI-CHANNEL APPROACH TO AUTHENTICATE USERS AND TRANSACTIONS IN PUBLIC AND PRIVATE NETWORK SETTINGS

(71) Applicant: MC Identity Solutions, Inc., New York, NY (US)

(72) Inventors: Eddie Cullen, Bronx, NY (US); Karl P. Kilb, III, New York, NY (US)

(73) Assignee: MC Identity Solutions, Inc., New York, NY (US)

(21) Appl. No.: 18/141,871

(22) Filed: May 1, 2023

Related U.S. Application Data
(60) Provisional application No. 63/337,227, filed on May 2, 2022.

(51) Int. Cl. G06Q 20/38; G06Q 20/40

(52) U.S. Cl. CPC G06Q 20/389; G06Q 20/401

(57) ABSTRACT

Embodiments of the present invention provide for methods and systems for providing an on-chain and off-chain authentication of Smart Contracts and other peer-to-peer transactions, including cryptography transactions, using security tokens that can be built into a Mobile Network Operator's secure infrastructure, leveraging the Mobile Network Operator's private, secure signaling channels, including but not limited to USSD channel and OTA channel, as well as satellite infrastructure, and other means of communication that are off-chain. The authentication can be done automatically, in the background, and/or with user involvement. In addition to ensuring security, these off-chain, multi-channel approaches using rules-based APIs will allow for infinitely greater scalability and maximum efficiency.

### CROSS REFERENCE TO RELATED APPLICATION(S)

This application claims the benefit of U.S. Provisional Patent Application No. 63/337,227, filed on May 2, 2022, the entirety of which is herein incorporated by reference.

### FIELD OF THE INVENTION

The present disclosure relates generally to systems and methods for a multi-layer, multi-channel approach to authenticate users and transactions in public and private network settings.

### BACKGROUND OF THE INVENTION

The Internet is a public network that is inherently vulnerable to attack as a single point of failure. Blockchains are shared ledger systems in which a record of transactions is maintained across a peer-to-peer network. Web3 is the name commonly used to describe a new form of Internet service that is built using blockchains. Blockchains are required to be decentralized, consistent, and scalable. Typical Web2 security involves firewalls, network segmentation, and intrusion prevention systems. Cyberattacks regularly breach such traditional Internet-based protections.

Currently, blockchains can attain only two of the three required properties (decentralization, consistency, and scalability), and they all must address issues with identity verification and transaction validation. Public blockchains (for example, Bitcoin and Ethereum) can attain primarily decentralization and consistency at the expense of scalability. In contrast, private blockchains (for example, Hyperledger and Ripple) attain consistency and scalability at the expense of decentralization. The goal is to create a blockchain that can attain all three properties—decentralization, consistency, and scalability—at the same time, while also ensuring security, as well as cost and energy efficiency. Public blockchain networks typically allow anyone to join and for participants to remain anonymous. A public blockchain uses Internet-connected computers to validate transactions and achieve consensus. Bitcoin is an example of a public blockchain, and it achieves consensus through “bitcoin mining.” Computers on the bitcoin network, or “miners,” try to solve a complex cryptographic problem to create proof of work and thereby validate the transaction. There are costs for the “gas fees” known as mining. Outside of public keys, there are few identity and access controls in this type of network. Private blockchains use identity to confirm membership and access privileges and typically only permit known organizations to join. Together, the organizations form a private, members-only “business network.” A private blockchain in a permissioned network achieves consensus through a process called “selective endorsement,” where known users verify the transactions. Only members with special access and permissions can maintain the transaction ledger. This network type requires more identity and access controls. In summary, blockchains are no different than other back-end platforms and require security from a wide variety of threats.

Accordingly, there is a need for security solutions with a multi-layer, multi-channel approach to authentication of users and transactions using verification tokens assigned to each individual or entity that are separate from the Web2 and Web3 environment because they reside in secure infrastructure and leverage the private secure channels of the mobile operator network. The results of which may include proof of verification consensus algorithm(s) to verify transactions using a multi-channel approach.

### SUMMARY OF THE INVENTION

Systems and methods are therefore described herein that overcome the problems described above. In this regard, embodiments of the present invention are directed to methods and systems for providing an on-chain and off-chain authentication of Smart Contracts and other peer-to-peer transactions, including cryptography transactions, using security tokens (“authentication settlement tokens”) that can be built into a Mobile Network Operator's (“MNO”) secure infrastructure, leveraging the MNO's private, secure signaling channels, including but not limited to USSD (Unstructured Supplementary Service Data) channel and OTA (Over-the-Air) channel, as well as satellite infrastructure, and other means of communication that are off-chain. The authentication can be done automatically, in the background, and/or with user involvement. In addition to ensuring security, these off-chain, multi-channel approaches using rules-based APIs (Application Programming Interfaces) will allow for infinitely greater scalability and maximum efficiency.

In one or more embodiments, the system may be used for verifying Smart Contract verification in the form of using Push USSD. The Smart Contracts produced on the blockchain are verified through a mobile number or mobile phone account of a user, sending transaction authentication through Push USSD. If the transaction is authorized via the Smart Contract software code, then Push USSD send a notification to a mobile phone number. Smart Contract and DApps can utilize the USSD channel via Mobile Network Operator for services provided to customers for authentication through multiple entry points.

In one or more embodiments, the system may be used to embed Push USSD technology for cryptography wallet transaction functionalities. A platform authorizing users to transact in Cryptography related technologies leveraging Push USSD with the MNOs enabling Smart Contract verification. The fundamental transactional embed mechanism produces a security checkmark and “yes or no” experience through Push USSD notifications to a user's device (e.g., smartphone, laptop, computer, tablet, etc.).

In one or more embodiments, the system may be used for leveraging Push USSD for off-chain transactions in cryptography for retail investors. The platform of the present system enables push notifications from financial institutions providing an on-ramp and off-ramp for cryptography related transactions off-chain. The on-ramp and off-ramp methodology provides an onboarding process to cryptography and fiat related transactions through Push USSD leveraging Mobile Network Operators.

These and other objects, features, and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Further objects, features, and advantages of the present disclosure will become apparent from the following detailed description taken in conjunction with the accompanying Figure showing illustrative embodiments of the present disclosure.

FIG. 1 depicts an exemplary algorithm implemented by a verification system in accordance with the principles of the present invention;

FIG. 2A depicts an exemplary flowchart of the system in accordance with the principles of the present invention;

FIG. 2B depicts an exemplary verification and role assignment process implemented by the system in accordance with the principles of the present invention;

FIG. 3A depicts an exemplary method in accordance with the principles of the present invention;

FIG. 3B depicts an exemplary method in accordance with the principles of the present invention;

FIG. 3C depicts an exemplary block diagram in accordance with the principles of the present invention;

FIG. 3D depicts an exemplary block diagram in accordance with the principles of the present invention;

FIG. 4A depicts an exemplary flowchart of the system in accordance with the principles of the present invention; and

FIG. 4B depicts an exemplary flowchart of the system in accordance with the principles of the present invention.

### DETAILED DESCRIPTION

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

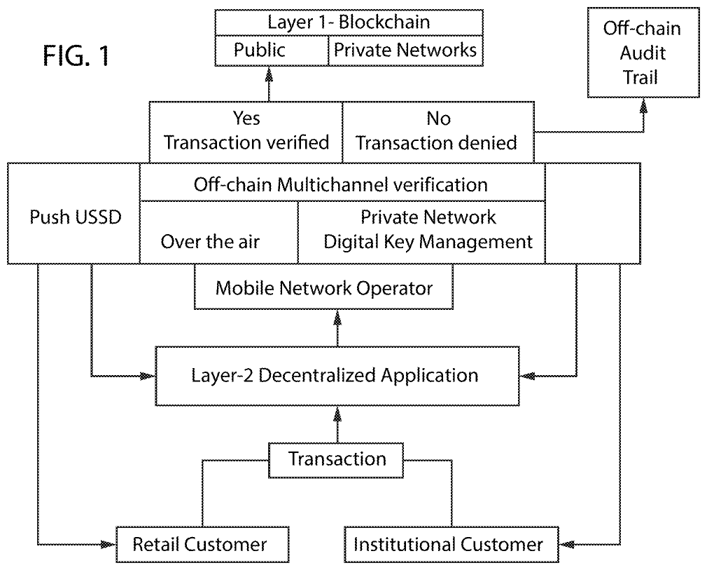

FIG. 1 depicts an exemplary algorithm implemented by a verification system in accordance with the principles of the present invention. The Proof of Transaction Verification is a consensus algorithm verifying transaction on both public and private networks on the blockchain. The overall process starts with the retail and institutional customer initiating a start of a transaction through a decentralized application and/or access point on either a public or private blockchain network. The transaction is then sent off the internet, otherwise known as off-chain, in the decentralized technology environment. The applicable mobile network operator verifies the transaction through origination data and/or a real-time notification using the operator's secure signaling channel (USSD) and/or other multichannel approaches. If the transaction is verified, then the Layer 2 technology, otherwise known as a decentralized application, accepts the transaction and the transaction data is stored instantaneously on each node across the public or private network. If the transaction is not verified, then the transaction is recorded within an off-chain database to provide an audit trail on malicious actors.

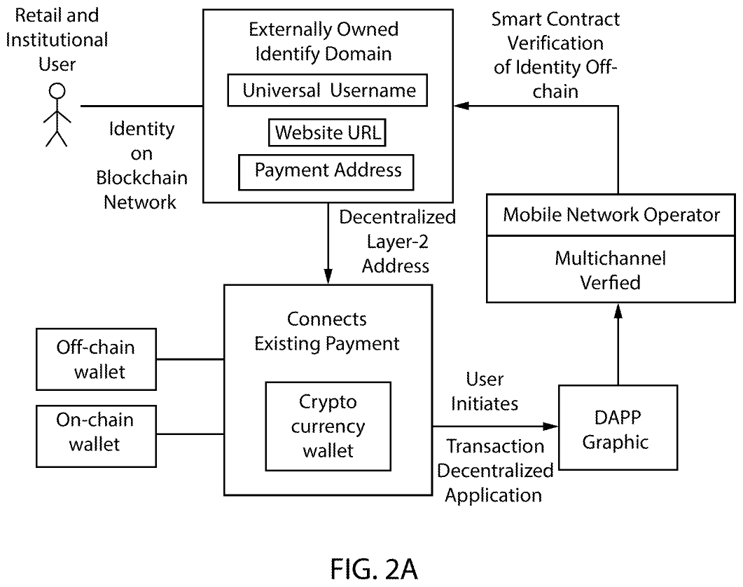

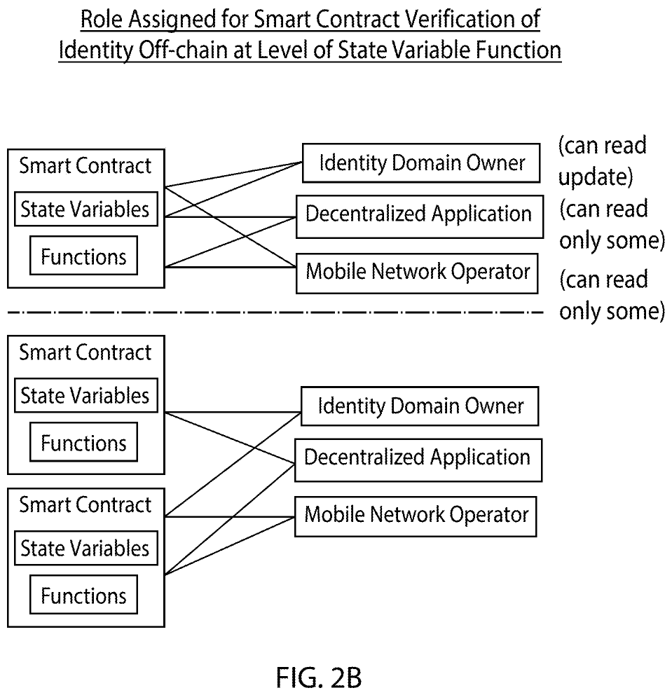

FIG. 2A depicts an exemplary flowchart of the system in accordance with the principles of the present invention. The Retail and/or Institutional Investor claims an externally owned identity domain as a KYC-type mechanism for identity verification on the blockchain. The user with their universal username, website URL, and payment address connects with their existing payment methodologies in the form of cryptocurrency wallets. The user initiates transactions through a decentralized application. The decentralized application sends the transaction data to the Mobile Network Operators before an off-the-internet or off-chain smart contract initiatives a yes-or-no multichannel verification of the externally owned identity domain.

FIG. 2B depicts an exemplary verification and role assignment process implemented by the system in accordance with the principles of the present invention. The role assignment for smart contract verification through the Proof of Transaction Verification consensus algorithm takes an approach of the Identity Domain Owner being able to read and write all state variables and across all functions as the owner of the domain, the decentralized application can read all state variables, yet can only see some of the functions, while the applicable Mobile Network Operator can only read the state variables for authentication purposes. The role assignment at the level of the contract remains the identity domain owner who can access all state variables and functions in all contracts, while the decentralized application has access to only the functions of the first smart contract and the Mobile Network Operator has access to the second contract.

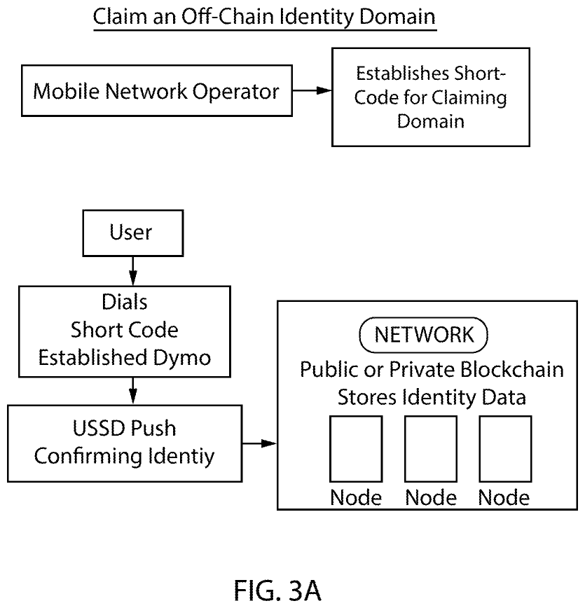

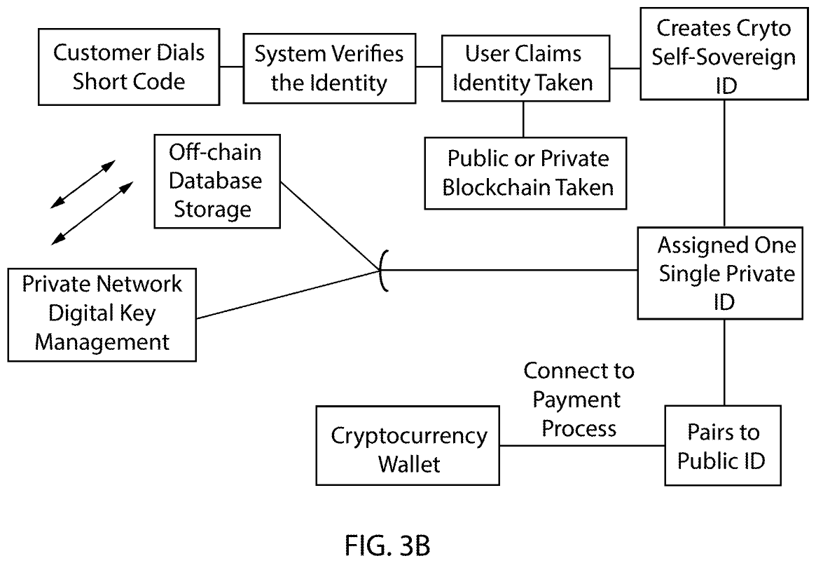

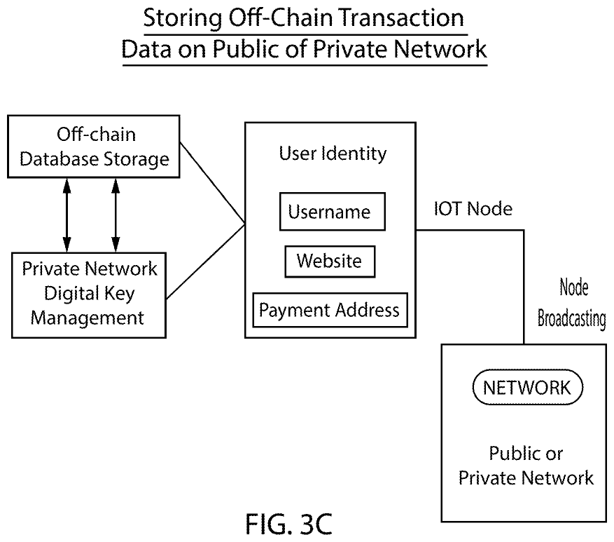

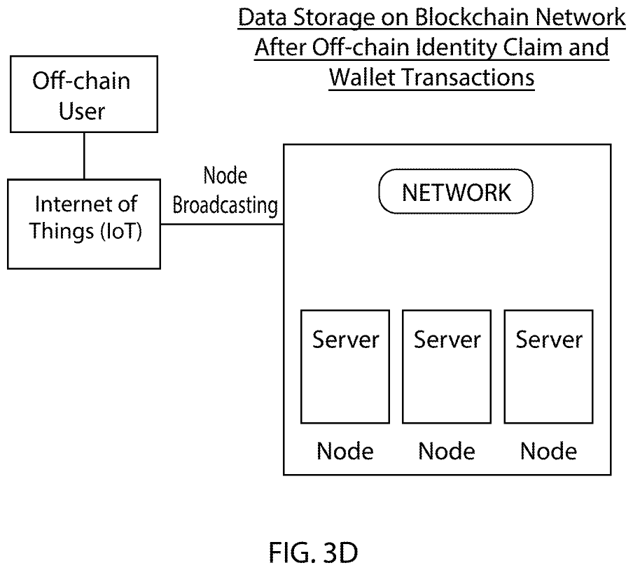

FIG. 3A depicts an exemplary method in accordance with the principles of the present invention. In some instances, a retail or institutional user may claim an identity domain through the Mobile Network Operator since they do not have access to the internet. For example. the Mobile Network Operator can establish a short-code for claiming an identity domain. The user can dial the short-code for claiming the identity domain, then the applicable mobile network operators would confirm the identity before storing the data on the public or private network.

FIG. 3B depicts an exemplary method in accordance with the principles of the present invention. After claiming an off-chain identity domain, the onboarding process for off-chain identity requires a customer to dial a short code and the system to verify the identity. The user then claims an identity token on a public or private blockchain creating a cryptographic self-sovereign ID. The assigned one single private ID is then stored on a private network and off-chain database leveraging varying multichannel approaches to verifying users through the Proof of Transaction Verification consensus algorithm. The private ID is then paired to a public ID before connecting the payment processor, otherwise known as a cryptocurrency wallet.

FIG. 3C depicts an exemplary block diagram in accordance with the principles of the present invention. The off-chain database and storage and private network digital key management authenticates to the private identity ID, and the public ID broadcasts to the public or private network after the Internet of Things (“IoT”) Node is broadcast. At times, off-chain users may go weeks or months without access to the internet, and once the user touches an IoT node, then the public or private network will store the data on ledger.

FIG. 3D depicts an exemplary block diagram in accordance with the principles of the present invention. The data storage on the public and private network occurs when the user comes in touch with the Internet of Things using its device. The identity claim and wallet claim are broadcast to the node after the user touches the public network. The proprietary off-chain database storage and private network digital key management systems broadcast to the public ID allowing for the public and private network to store the data on the network.

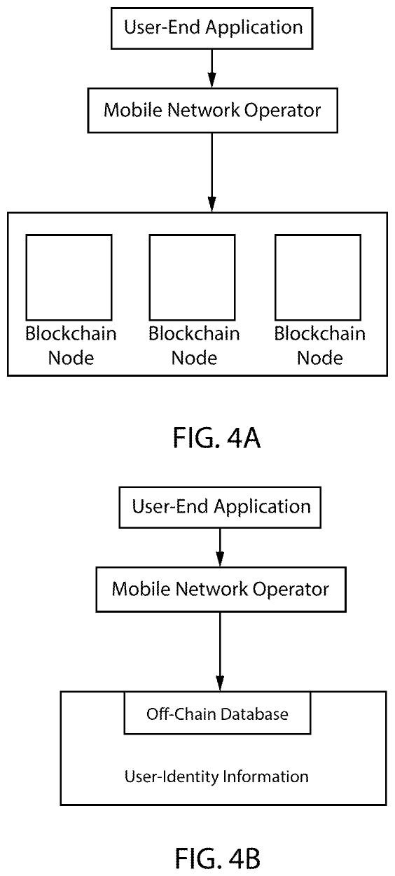

FIG. 4A depicts an exemplary flowchart of the system in accordance with the principles of the present invention. When the Proof of Transaction Verification Consensus Algorithm authenticates “Yes” for a transaction then the User-End decentralized application sends a multichannel notification to the applicable Mobile Network Operator and the Mobile Network Operator stores the data instantaneously on each node in the respective public or private blockchain network.

FIG. 4B depicts an exemplary flowchart of the system in accordance with the principles of the present invention. When the Proof of Transaction Verification Consensus Algorithm authenticates “No” for a transaction, then the user-end decentralized application sends a multichannel notification to the applicable Mobile Network Operator and the Mobile Network operators stores the data instantaneously in an off-chain database to produce an audit trail on potentially fraudulent or malicious activity.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification and drawings, can be used synonymously in certain instances, including, but not limited to, for example, data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

1. A computer-implemented method for processing data to authenticate users and transactions, the method comprising:
receiving from a customer an initiation of a transaction through an access point on a blockchain network,
sending the transaction off internet,
verifying the transaction with origination data,
accepting the transaction in response to a successful verification, and
storing transaction data from the transaction on each node across the blockchain network.

2. The computer-implemented method of claim 1,
wherein the method can also verify the transaction with a real-time notification to the customer using a secure signaling channel (USSD).

3. The computer-implemented method of claim 1,
wherein the method can also verify the transaction with a short messaging service.

4. The computer-implemented method of claim 1,
wherein the method can also verify the transaction with an interactive voice response.

5. The computer-implemented method of claim 1,
wherein in response to a non-successful verification, the transaction is recorded in an off-internet database.

6. The computer-implemented method of claim 1,
wherein the customer can claim an externally owned identity domain as a KYC-type mechanism to verify identity of the customer on the blockchain.

7. The computer-implemented method of claim 6,
wherein the customer is required to dial a short code; and
wherein the user is assigned a cryptographic self-sovereign ID that is then stored on the blockchain network.

8. The computer-implemented method of claim 7,
wherein the cryptographic self-sovereign ID is paired to a public ID before connecting to a payment processor.

9. The computer-implemented method of claim 1,
wherein the access point on the blockchain network is private.

10. The computer-implemented method of claim 8,
wherein the public ID is broadcasted to the blockchain network after an internet of things is broadcasted.

11. A computer-implemented authentication system for authenticating users and transactions over a network, the system comprising:
at least one memory to store instructions, and
at least one computer processor to execute the instructions stored in the at least one memory to perform steps including:
receiving from a customer an initiation of a transaction through an access point on a blockchain network,
sending the transaction off internet,
verifying the transaction with origination data,
accepting the transaction in response to a successful verification, and
storing transaction data from the transaction on each node across the blockchain network.
